(19) United States
(12) Patent Application Publication
(10) Pub. No.: US 2015/0088491 A1
(43) Pub. Date: Mar. 26, 2015

(54) KEYWORD EXTRACTION APPARATUS AND METHOD

(71) Applicant: Kabushiki Kaisha Toshiba, Tokyo (JP)

(72) Inventors: Kosei Fume, Kawasaki Kanagawa (JP); Masayuki Okamoto, Kawasaki Kanagawa (JP); Hisayoshi Nagae, Yokohama Kanagawa (JP)

(21) Appl. No.: 14/489,832

(22) Filed: Sep. 18, 2014

(30) Foreign Application Priority Data
Sep. 20, 2013 (JP) 2013-196232

(51) Int. Cl. G06F 17/27; G06F 17/30; G06F 17/24

(52) U.S. Cl. CPC G06F 17/27; G06F 17/241; G06F 17/30011; G06F 17/30598
USPC 704/9

(57) ABSTRACT

According to one embodiment, a keyword extraction apparatus includes a separation unit, a generation unit, a calculation unit, a first update unit, a second update unit. The separation unit separates a first annotation from each of a plurality of documents. The generation unit generates one or more document clusters by calculating a score of keywords and performing clustering on documents having a correlation value higher than a threshold. The calculation unit calculates a characteristic quantity in accordance with a type of a second annotation. The first update unit updates the score of the keyword to which the second annotation is added, based on the characteristic quantity. The second update unit updates the one or more document cluster in accordance with the updated score to obtain an updated document cluster.

### CROSS-REFERENCE TO RELATED APPLICATIONS

This application is based upon and claims the benefit of priority from Japanese Patent Application No. 2013-196232, filed Sep. 20, 2013, the entire contents of which are incorporated herein by reference.

### FIELD

Embodiments described herein relate generally to a keyword extraction apparatus and method.

### BACKGROUND

In recent years, the opportunities for using electronic documents are increasing. The use of electronic documents and target content are not limited to viewing of internal documents on a desktop computer at companies; various kinds of information such as widely-published blogs, review sites, and electronic bulletin boards are readily accessible on portable tablets and smart phones.

On the other hand, users need to make an effort to effectively access the documents and content they search for from among a vast amount of documents. For example, a reader's interest in documents and content can be attracted by presenting links to a document in chronological order that is linked with a calendar function, or by presenting some keywords called a tag cloud. Moreover, there is a means of introducing a different document or a reference link by showing a user's comments and related articles on the same document or content.

### BRIEF DESCRIPTION OF THE DRAWINGS

FIG. 1 is a block diagram of a keyword extraction apparatus according to the present embodiment.

FIG. 2 is a flowchart illustrating the keyword extraction apparatus according to the present embodiment.

FIG. 3 is a drawing of an example of annotations added to a document.

FIG. 4 is a drawing of an example of matching relationships between a document and keywords.

FIG. 5 shows an example of representative words in a document cluster according to the present embodiment.

FIG. 6 shows an example of a keyword list output from a keyword output unit.

FIG. 7 shows an example of annotations input by a user.

FIG. 8 shows an example of keyword updating process at a keyword score update unit.

FIG. 9 shows an example of representative words in an updated document cluster.

FIG. 10 shows an example of an updated keyword list output from a keyword output unit.

### DETAILED DESCRIPTION

Some procedures for presenting keywords extracted from Web documents viewed by a user and office documents created and managed by a user for the purpose of providing search keywords and summary-like descriptions. For example, there is a procedure of extracting keywords from a document for both general terms and technical terms.

However, if annotations indicating a user's instructions, such as underlines and circles, are explicitly shown, these annotations cannot be reflected to those presented keywords. In a case where a group of documents accessed by a user is a target for keyword extraction, unlike a case where vast amounts of Web documents are dealt with, it is difficult to present keywords for a refined search and to discover keywords that were not noticed when a user viewed the documents by simple utilization of frequency information.

When keywords different from a user's preference and interest are presented because of the small number of documents that are a target for keyword extraction, the differences of the presented keywords and the user's preference and interest stand out, and keywords as a search starting point become indeterminate because the presented keywords that are updated depend strongly on the content of a group of documents to be added or deleted; as a result, a pass to a document that a user wishes to access may be lost.

In general, according to one embodiment, a keyword extraction apparatus includes a separation unit, a first extraction unit, a second extraction unit, a generation unit, a calculation unit, a first update unit, a second update unit. The separation unit is configured to separate a first annotation from each of a plurality of documents, the first annotation expressing a user's intention, the plurality of documents each being a document that the first annotation is added to texts in the document. The first extraction unit is configured to extract general terms from the plurality of documents based on pre-defined word class information. The second extraction unit is configured to extract, from the plurality of documents, complex words different from general terms as user terms based on appearance frequencies of the complex words. The generation unit is configured to generate one or more document clusters by calculating a score of keywords that are the general terms and the user terms and performing clustering on documents having a correlation value higher than a threshold, the correlation value being a value of correlation between the plurality of documents based on the score. The calculation unit is configured to calculate a characteristic quantity in accordance with a type of a second annotation if the second annotation added to a keyword included in the one or more document cluster by a user is obtained. The first update unit is configured to update the score of the keyword to which the second annotation is added, based on the characteristic quantity. The second update unit is configured to update the one or more document cluster in accordance with the updated score to obtain an updated document cluster.

In the following, a keyword extraction apparatus, method and program according to the present embodiment will be explained in detail with reference to the drawings. In the description of the embodiment below, the components referenced by the same numbers perform the same operations throughout the embodiment, and repetitive descriptions will be omitted for brevity.

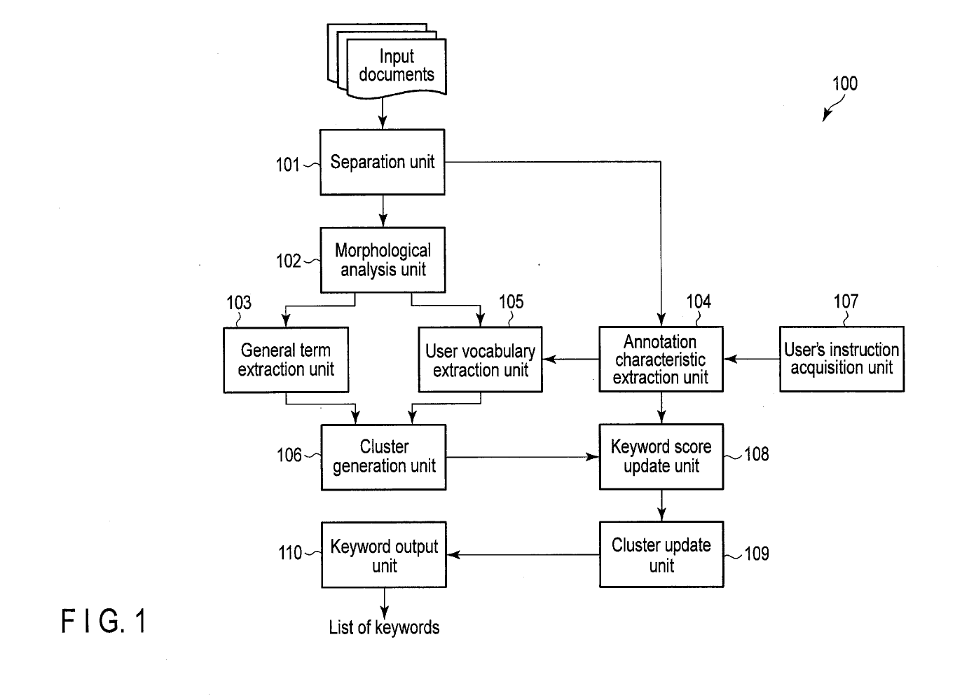

The keyword extraction apparatus according to the present embodiment will be explained herein with reference to the block diagram of FIG. 1.

A keyword extraction apparatus 100 according to the present embodiment includes a separation unit 101, a morphological analysis unit 102, a general term extraction unit 103, an annotation characteristic extraction unit 104, a user vocabulary extraction unit 105, a cluster generation unit 106, a user's instruction acquisition unit 107, a keyword score update unit 108, a cluster update unit 109, and a keyword output unit 110.

The separation unit 101 receives an input document and separates texts from a user's annotation added by a user to the input document (may be referred to as “a first annotation”). The term “separate” indicates recognition that the texts are different from the user's annotation. The input document may be a Web document collected from the Web (Internet capable network) to which a user's annotation is added, or a document created by document creation software to which a user's annotation is added.

An annotation herein refers to strokes that express a user's intention, such as underlines, circles, strike-throughs, and comments, mainly handwritten by a user. It can be assumed that underlines and circles are emphasis instructions to increase an importance level, and strike-throughs are deletion instructions to reduce an importance level. Not only handwritten annotations but also annotations input by an application, etc. can be processed by the keyword extraction apparatus.

A method of designating annotations is not limited to the operation of a pen or a pointing device, etc. Double-tapping and holding-down as emphasis instructions, and swiping as deletion instructions on a touch panel of a tablet device, etc. can also be processed similarly to annotations by a pen, etc.

The analysis unit 102 receives the input text from the separation unit 101 and performs morphological analysis on the texts in the input document.

The general term extraction unit 103 receives the input document on which the morphological analysis is performed, and extracts general terms from the input document. In the process of extracting general terms, morphemes to which a specific property is added and katakana words that are unknown can be extracted as general terms from nouns by referring to, for example, a dictionary in which word class information, etc. are defined in advance.

The annotation characteristic extraction unit 104 receives the annotation from the separation unit 101, and extracts a characteristic quantity based on a location of the annotation in the input document and a type of annotation. In a case of receiving an annotation from a user (may be referred to as “a second annotation”) added to a keyword list (will be described later) from the user instruction acquisition unit 107 (will be described later), a characteristic quantity can be extracted for this annotation in a manner as described above.

The user vocabulary extraction unit 105 receives the input document on which morphological analysis was performed from the morphological analysis unit 102, and calculates an appearance frequency of morpheme patterns to obtain compounds extracted from the appearance frequency as user terms. User terms include user-created words and abbreviations shared in, for example, an organization to which a user belongs. If any annotations are added to the texts in the input document, the texts to which annotations are added and texts of added comments are also extracted as user terms.

The cluster generation unit 106 obtains the general terms from the general term extraction unit 103 and the user terms from the user vocabulary extraction unit 105, and performs document clustering using the general terms and user terms as keywords to generate at least one document cluster. The detail of document clustering will be described later.

The user instruction acquisition unit 107 acquires the user's annotations via a user interface.

The keyword score update unit 108 receives the document clusters from the cluster generation unit 106 and the characteristic quantities of the annotations from the annotation characteristic extraction unit 104. The keyword score update unit 108 updates scores of the keywords included in the documents of the document cluster based on the characteristic quantities of the annotations.

The cluster update unit 109 receives the document clusters and the scores of updated keywords from the keyword score update unit 108, and updates the document clusters in accordance with the updated scores to obtain updated document clusters.

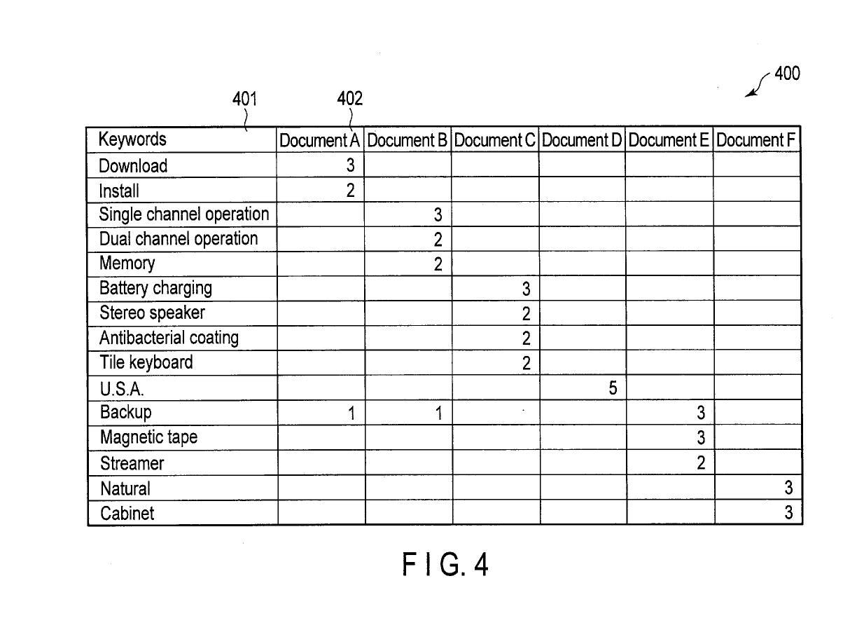

The keyword output unit 110 outputs a keyword list based on the document cluster generated at the cluster generation unit 106. If an annotation is added to the keyword list by a user, the keyword output unit 110 receives the updated document clusters from the cluster update unit 109, and outputs a keyword corresponding to the document clusters. An example of keyword output will be described later with reference to FIG. 4.

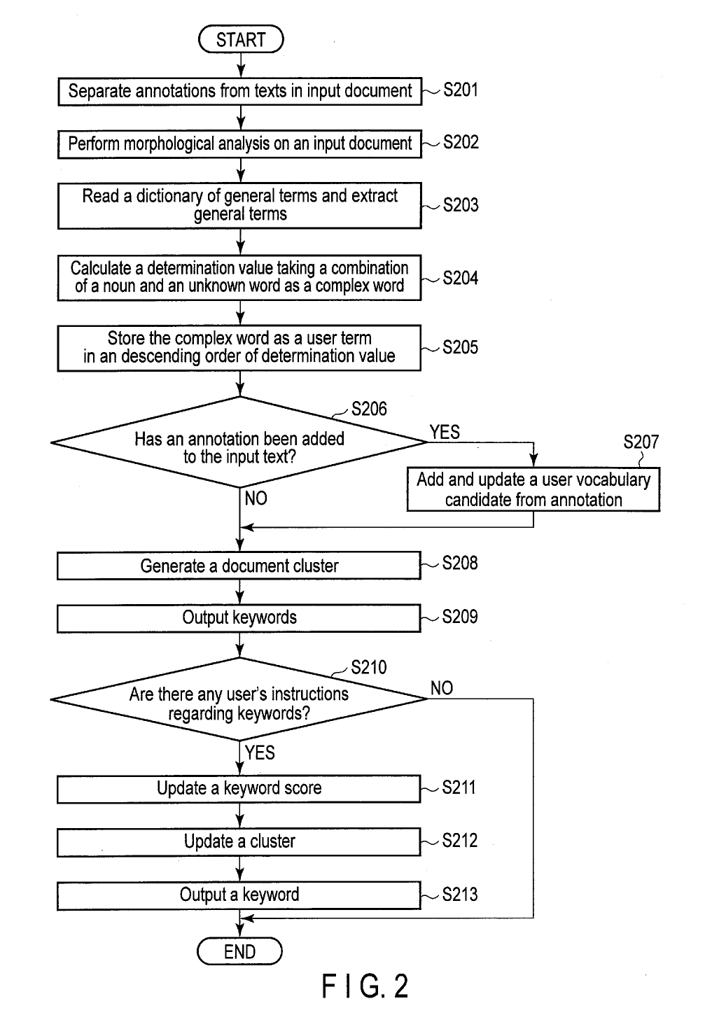

Next, the operation of the keyword extraction apparatus 100 is explained with reference to the flowchart of FIG. 2.

At step S201, the separation unit 101 separates texts from annotations for each of a plurality of input documents.

At step S202, the morphological analysis unit 102 performs a morphological analysis on the texts. As a result of the morphological analysis, word class information is added to the texts which are segmented into morphemes.

At step S203, the general term extraction unit 103 refers to a list of general terms which is registered in advance as a general term dictionary, and extracts general terms from the texts to which the word class information is added.

At step S204, the user vocabulary extraction unit 105 counts an appearance frequency for each compound, assuming that a text of a noun and an unknown word next to each other in combination as a compound, based on the result of the morphological analysis, and calculates a determination value to determine each compound as a user term.

Specifically, an MC-Value is calculated by Expression (1) as a determination value for a compound.

MC-Value(CN)=length(CN)×(n(CN)−t(CN)/c(CN)) (1)

CN: Compound Noun

length(CN): Length of CN (the number of constituent nouns)

n(CN): The number of appearances of CN in corpus

t(CN): The number of appearances of compound nouns including CN longer than CN

c(CN): The number of different appearances of compound nouns including CN longer than the CN which is a current target

A C-value may be used instead of the MC-value as a determination value.

At step S205, the user vocabulary extraction unit 105 obtains the compounds as user terms in descending order of the determination value calculated by Expression (1).

At step S206, the annotation characteristic extraction unit 104 determines whether or not annotations are added to the input document. If any annotation is added to the input document, the process proceeds to step S207, and if no annotations are added, the process proceeds to step S208.

At step S207, the annotation characteristic extraction unit 104 adds the texts to which the annotations are added to the user terms. For example, if there are markings (such as a circle or a square) by a handwriting interface in the document, the marked text is determined to be a user term, and if there is a highlighted or underlined text, the marked text is determined to be a user term. If there are comments overlapped on the texts, the comments may be recognized as a text and determined to be a user term.

At step S208, the cluster generation unit 106 performs document clustering on the input documents based on the general terms and user terms, and generates document clusters. As a procedure of document clustering, for example, a score of a keyword is calculated using the general terms and user terms as keywords. Then, the documents are classified by clustering documents having a correlation level higher than a threshold based on keyword scores. For the document clustering, a general method for clustering can be adopted.

At step S209, the keyword output unit 110 presents a keyword list of representative keywords selected from the keywords included in the document cluster.

At step S210, the user instruction acquisition unit 107 determines whether or not there has been an instruction from the user for each keyword. If there is a user's instruction, i.e., an annotation, the process proceeds to step S211, and if there is no annotation input from the user, the process proceeds to step S212.

At step S211, the keyword score update unit 108 updates keyword scores based on the annotation.

At step S213, the cluster update unit 109 updates the document cluster in accordance with the updated keyword scores.

At step S214, the keyword output unit 110 outputs a keyword list including the updated keywords. Here, the operation of the keyword extraction apparatus 100 is finished.

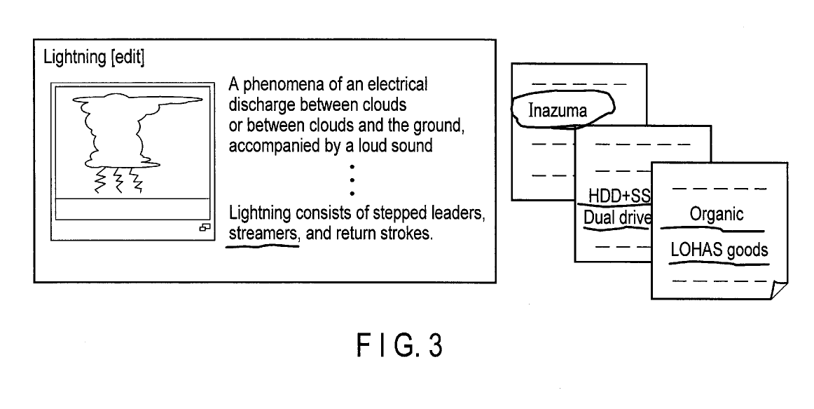

Next, an example of annotations added to a document is explained with reference to FIG. 3.

FIG. 3 is an example of annotations, and is a result of underlining the text in an article on a Web document. In this example, the word “streamer” is underlined. The example also shows the annotated Web documents; the complex word “Inazuma” is circled, the term “HDD+SDD dual drive” is underlined, and the words “organic” and “LOHAS goods” are underlined. Those texts to which annotations are added are also regarded as user terms.

Next, an example of matching relationships between documents and keywords is explained with reference to FIG. 4.

In the example shown in FIG. 4, clustering is performed on Document A to Document F, and table 400 shows the matching relationships between keywords 401 and documents 402. The keywords 401 are the texts included in the general terms and user terms. The documents 402 are documents including annotations.

Specifically, the document 402 “Document A” is associated with “download,” “install,” and “backup” as the keywords 401. The score of each of the keywords in Document A is “3”, “2”, and “1”, respectively.

The score can be calculated based on Expression (2) below:

Score=Appearance Statistical Quantity+Annotation Bias Value (2)

Alternatively, a value of the appearance statistical quantity multiplied by the annotation bias value can be used for the score.

The appearance statistical quantity may simply be the number of times of appearance of a keyword in a document, or may be a TF/IDF value. The annotation bias value is a characteristic quantity that is set in accordance with the type of annotation. Herein, the annotation bias value is the number of times of appearance of a keyword in a document. Thus, it can be understood from the table 400 that the word “download” appears three times, “install” twice, and “backup” once in Document A.

A similarity level between documents can be calculated based on those values. The calculation of similarity level may be achieved by using a cosine similarity.

Specifically, a cosine similarity can be calculated by expressing the keywords included in Document A and Document B in vectors.

A vector of Document A can be expressed as Vec (A)={3, 2, 0, 0, 0, 0, 0, 0, 0, 0, 1, 0, 0, 0, 0}, and a vector of Document B can be expressed as Vec (B)={0, 0, 3, 2, 2, 0, 0, 0, 0, 0, 1, 0, 0, 0, 0}. Thus, a cosine similarity can be calculated using cos (vec (A), vec (B))=vec (A)*vec (B)/|A| |B|. Herein, the asterisk denotes multiplying, and “| |” denotes absolute values.

In this case, a cosine similarity can be obtained as:

1/(sqrt(9+4+1)*sqrt(9+4+4+1))=1/sqrt(14)*sqrt(18)≈0.063

A cosine similarity is calculated between documents as described above, and a document cluster can be generated by clustering using, for example, the k-means method.

The keywords obtained in the descending order of score values from each of a plurality of document clusters are set as representative words of the document cluster.

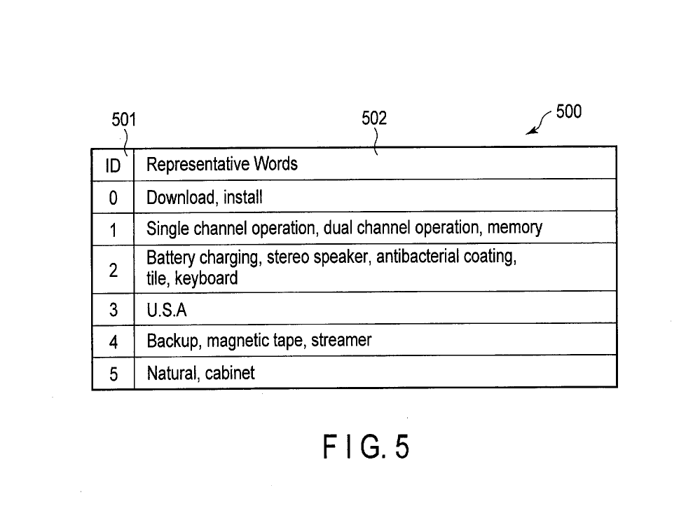

Next, an example of a document cluster is explained with reference to FIG. 5. FIG. 5 shows the table 500 in which a relevancy between documents is defined in accordance with keywords and scores, and the table 500 shows a result of clustering performed in accordance with the similarity level between documents. The table 500 includes ID 501 and representative words 502.

ID 501 is a document cluster identifier. Representative words 502 are the representatives of keywords included in each document cluster.

Specifically, {download, install}, {single channel operation, dual channel operation, memory}, {battery charging, stereo speaker, antibacterial coating, tile keyboard}, {USA}, {backup, magnetic tape, streamer}, {natural, cabinet} are the representative words of each document cluster.

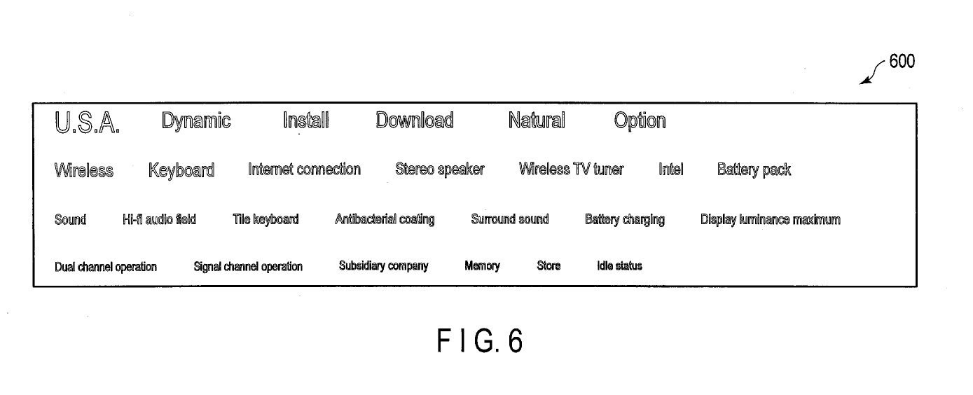

Next, an example of a keyword list output from the keyword output unit 110 is explained with reference to FIG. 6.

In the example shown in FIG. 6, the representative words of the keywords are shown in the form of tag cloud 600. The tag cloud 600 shows the representative words in different font sizes in accordance with the score values.

The scores for the user terms obtained from the result of extracting user terms by the user's vocabulary extraction unit 105 can be calculated based on Expression (1). As for the terms output from the general terms extraction unit 103, the scores have not been explicitly obtained. Thus, the scores are defined in advance in accordance with a method of extracting general terms. In this example, if more detailed property information (person's name, organization's name, etc.) is added as a “noun”, a pre-processing is performed to give a word a higher score than a score given to a general “noun”, for example.

Also, in consideration of score information obtained at the user's vocabulary extraction unit 105, the pre-processing can be performed to give a value adjusted so as to include a fixed number of terms to a keyword obtained from the result of extracting general terms.

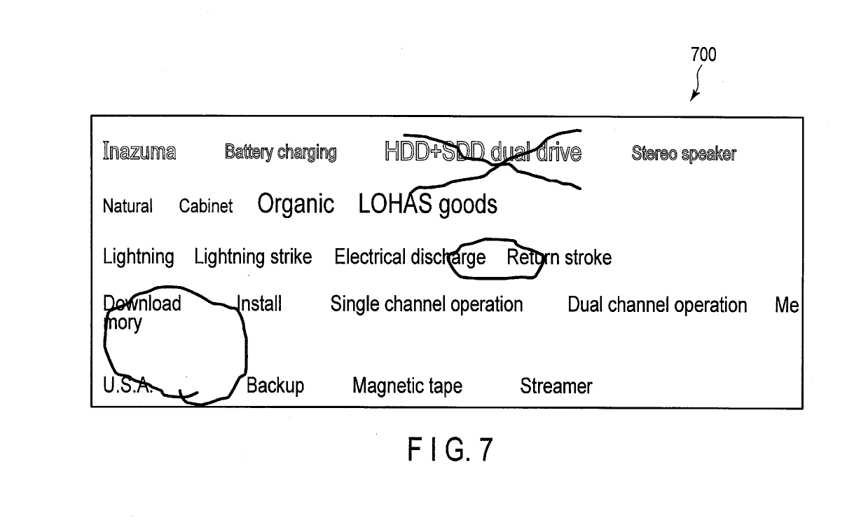

Next, an example of annotations obtained by the user's instruction acquisition unit 107 is explained with reference to FIG. 7.

An example shown in FIG. 7 displays a tag cloud 700 of the representative words of the document clusters. The representative words from one document cluster are displayed separately from those in a different document cluster. In this example, the representative words in the same row are the representative words obtained from the same document cluster.

The user gives annotations, such as a circle and a cross, to the representative words displayed in the tag cloud.

In the example shown in FIG. 7, the representative word “HDD+SDD dual drive” is crossed-out. In this case, as the user may think that this keyword is unnecessary, the crossed-out “HDD+SDD dual drive” may be deleted from the representative words of the cluster, or the score for “HDD+SDD dual drive” may be lowered. For example, lower a score, data may be manipulated to bias the score (to change the score to zero or a negative value), or to flag the score inside of the data so as not to display the keyword.

Furthermore, in this example, the representative words “electrical discharge” and “return stroke” in the same document cluster are marked. In this case, as the user may think that the keyword is important, the scores of the marked keywords may be increased, or flagged to anchor down the keywords, or set at a value greater than a threshold for displaying in the cluster. Also, the marked keywords in the tag cloud may be so-called “pinned” to display those keywords constantly.

Furthermore, in this example, the representative words “download”, “memory”, and “U.S.A.” are marked. If multiple representative words in different document clusters are marked as in this example, the marking can be regarded as a user's instruction to associate one of the representative words with another. In this case, the co-occurrence values for the words may be increased so that the words are selected as the words on the same document cluster.

In the following, a specific example of a process of updating a document cluster, using the example in which the representative word “streamer” shown in FIG. 7 is associated with the representative term “lightning strike” in a different document cluster.

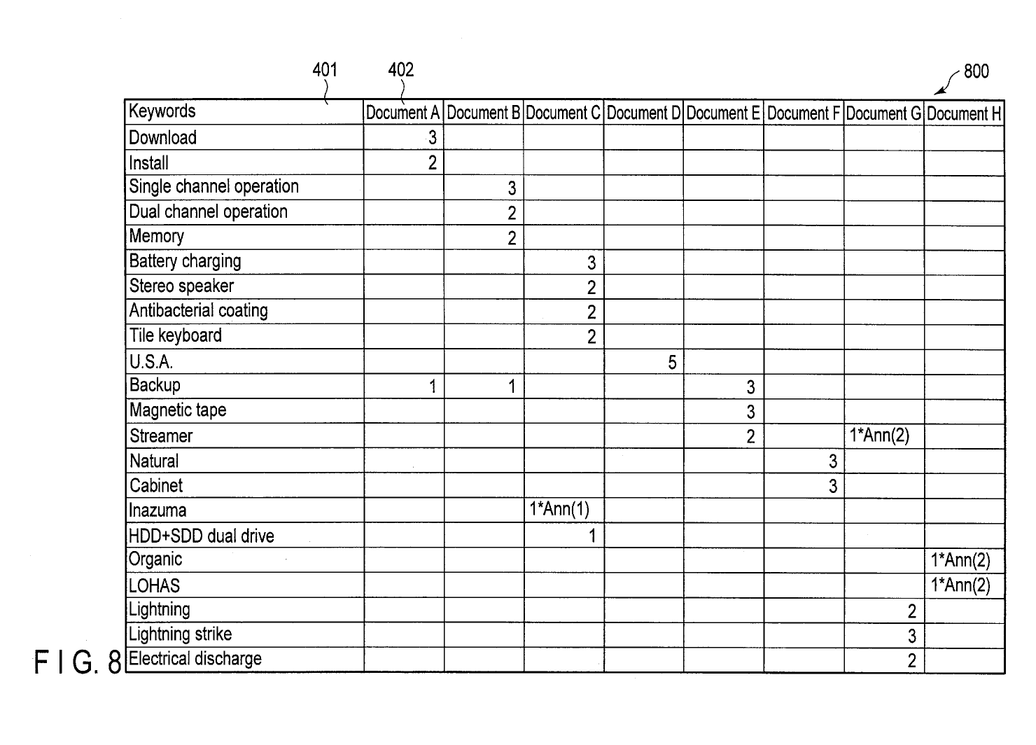

An example of a keyword updating process at the keyword score update unit 108 is explained with reference to FIG. 8.

Table 800 in FIG. 8 shows the relationship of keywords for each updated document. In this example, Document G and Document H are newly added to the documents in FIG. 3, and a case in which two different annotations are added to the keywords is assumed.

Herein, the score of a keyword to which an annotation is added can be calculated by adding an annotation bias value, as shown in Expression (2). In the example of FIG. 7, “Ann (p)” is multiplied as an annotation bias value (a characteristic quantity). Herein, p represents a positive integer. A different annotation bias value is assigned in accordance with the type of annotation.

For example, suppose that the value 10 is assigned to circling a text, and the value 5 is assigned to underlining (=Ann (2)). As a result, the score for the word “Inazuma” which appears in Document C 1×10=10, and therefore, the score is 10, and the score for the word “streamer” which appears in Document G is 5, and furthermore, the scores for the terms “organic” and “LOHAS” which appear in Document H are updated to 5, respectively.

These values may be fixed in advance, or may be dynamically updated based on the statistical information of the words obtained from accumulated documents.

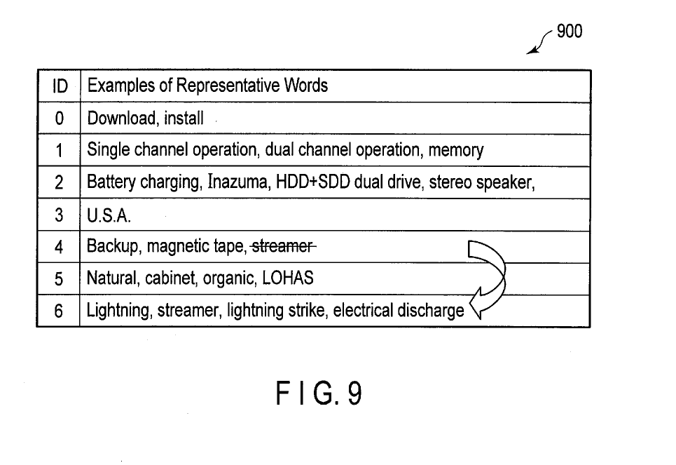

Next, an example of the representative words in an updated document cluster is explained with reference to FIG. 9.

In the table 900 shown in FIG. 9, the representative words are updated based on the updated characteristic quantity. For example, the table shows that “Inazuma” and “HDD+SDD dual drive” are newly added, and the words such as “organic” and “LOHAS” are newly added to ID5.

The score of the keyword “streamer”, which existed in the document cluster ID4, is updated by the annotation this time, and “streamer” is newly linked to the document cluster ID6.

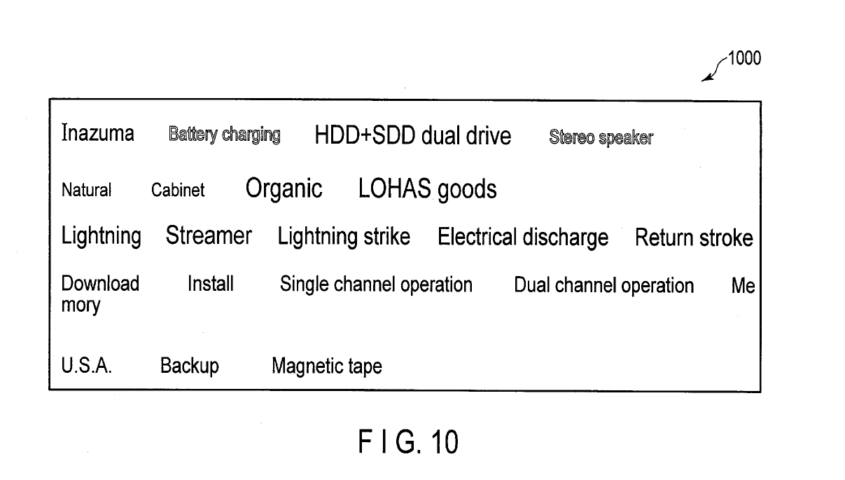

Next, an example of an updated keyword list output from the keyword output unit 110 is explained with reference to FIG. 10.

FIG. 10 is an example illustrating the representative words in the form of a tag cloud 1000 based on the updated document clusters.

In the tag cloud 1000 shown in FIG. 10, the characteristic of the cluster is visually expressed by illustrating the keywords in the same cluster in the same row. Also, visual effects are added to the keywords, such as different font colors, to express differences in annotation.

The representative words may be distinguished so that the representative words are linked with functions, such as a function of constant display (a function of pinning down on a display). As for new clusters, a threshold for the keywords to be displayed is lowered so that more keywords are to be displayed in order to indicate context information in greater detail.

According to the embodiment described above, clustering is performed on a document to which annotations are added by a user, and the representative words of the document clusters are displayed; thus, it is possible to display keywords based on the user's tendencies in collecting and viewing documents, and to explicitly maintain not only new keywords corresponding to the user's tendency in registering of new documents, but also the keywords marked as important by the user. Moreover, it is possible to output a keyword list in which a user's opinion is reflected by referring to the user's annotations added to the keywords and displaying keywords that are updated by updating the characteristic quantities of the keywords.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A keyword extraction apparatus, comprising:
a separation unit configured to separate a first annotation from each of a plurality of documents, the first annotation expressing a user's intention, the plurality of documents each being a document that the first annotation is added to texts in the document;
a first extraction unit configured to extract general terms from the plurality of documents based on pre-defined word class information;
a second extraction unit configured to extract, from the plurality of documents, complex words different from general terms as user terms based on appearance frequencies of the complex words;
a generation unit configured to generate one or more document clusters by calculating a score of keywords that are the general terms and the user terms and performing clustering on documents having a correlation value higher than a threshold, the correlation value being a value of correlation between the plurality of documents based on the score;
a calculation unit configured to calculate a characteristic quantity in accordance with a type of a second annotation if the second annotation added to a keyword included in the one or more document cluster by a user is obtained;
a first update unit configured to update the score of the keyword to which the second annotation is added, based on the characteristic quantity; and
a second update unit configured to update the one or more document cluster in accordance with the updated score to obtain an updated document cluster.

2. The apparatus according to claim 1, further comprising an output unit configured to extract a representative word which is a keyword representative of each updated document cluster, and classify and display a plurality of representative words on a document cluster-by-document cluster basis,
wherein the second annotation includes a deletion instruction to lower an importance level, an emphasis instruction to increase the importance level, and an association instruction to associate the representative word to another, the first update unit updates the score by using the characteristic quantity in accordance with at least one of the deletion instruction, the emphasis instruction and the association instruction.

3. The apparatus according to claim 1, wherein the calculation unit calculates the characteristic quantity in accordance with a type of the first annotation, and the generation unit calculates the score using the characteristic quantity in accordance with the type of the first annotation if calculating the score.

4. The apparatus according to claim 2, wherein the output unit displays a representative word to which the second annotation is added with an emphasis if the second annotation is the emphasis instruction.

5. The apparatus according to claim 2, wherein the output unit displays a representative word to which the second annotation is added constantly if the second annotation is the emphasis instruction.

6. A keyword extraction method, comprising:
separating a first annotation from each of a plurality of documents, the first annotation expressing a user's intention, the plurality of documents each being a document that the first annotation is added to texts in the document;
extracting general terms from the plurality of documents based on pre-defined word class information;
extracting, from the plurality of documents, complex words different from general terms as user terms based on appearance frequencies of the complex words;
generating one or more document clusters by calculating a score of keywords that are the general terms and the user terms and performing clustering on documents having a correlation value higher than a threshold, the correlation value being a value of correlation between the plurality of documents based on the score;
calculating a characteristic quantity in accordance with a type of a second annotation if the second annotation added to a keyword included in the one or more document cluster by a user is obtained;
updating the score of the keyword to which the second annotation is added, based on the characteristic quantity; and
updating the one or more document cluster in accordance with the updated score to obtain an updated document cluster.

7. The method according to claim 6, further comprising extracting a representative word which is a keyword representative of each updated document cluster, and classifying and displaying a plurality of representative words on a document cluster-by-document cluster basis,
wherein the second annotation includes a deletion instruction to lower an importance level, an emphasis instruction to increase the importance level, and an association instruction to associate the representative word to another, the updating the score updates the score by using the characteristic quantity in accordance with at least one of the deletion instruction, the emphasis instruction and the association instruction.

8. The method according to claim 6, wherein the calculating the characteristic quantity calculates the characteristic quantity in accordance with a type of the first annotation, and the generating the one or more document clusters calculates the score using the characteristic quantity in accordance with the type of the first annotation if calculating the score.

9. The method according to claim 7, wherein the displaying the plurality of representative words displays a representative word to which the second annotation is added with an emphasis if the second annotation is the emphasis instruction.

10. The method according to claim 7, wherein the displaying the plurality of representative words displays a representative word to which the second annotation is added constantly if the second annotation is the emphasis instruction.

11. A non-transitory computer readable medium including computer executable instructions, wherein the instructions, when executed by a processor, cause the processor to perform a method comprising:
separating a first annotation from each of a plurality of documents, the first annotation expressing a user's intention, the plurality of documents each being a document that the first annotation is added to texts in the document;
extracting general terms from the plurality of documents based on pre-defined word class information;
extracting, from the plurality of documents, complex words different from general terms as user terms based on appearance frequencies of the complex words;
generating one or more document clusters by calculating a score of keywords that are the general terms and the user terms and performing clustering on documents having a correlation value higher than a threshold, the correlation value being a value of correlation between the plurality of documents based on the score;
calculating a characteristic quantity in accordance with a type of a second annotation if the second annotation added to a keyword included in the one or more document cluster by a user is obtained;
updating the score of the keyword to which the second annotation is added, based on the characteristic quantity; and
updating the one or more document cluster in accordance with the updated score to obtain an updated document cluster.

12. The medium according to claim 11, further comprising extracting a representative word which is a keyword representative of each updated document cluster, and classifying and displaying a plurality of representative words on a document cluster-by-document cluster basis,
wherein the second annotation includes a deletion instruction to lower an importance level, an emphasis instruction to increase the importance level, and an association instruction to associate the representative word to another, the updating the score updates the score by using the characteristic quantity in accordance with at least one of the deletion instruction, the emphasis instruction and the association instruction.

13. The medium according to claim 11, wherein the calculating the characteristic quantity calculates the characteristic quantity in accordance with a type of the first annotation, and the generating the one or more document clusters calculates the score using the characteristic quantity in accordance with the type of the first annotation if calculating the score.

14. The medium according to claim 12, wherein the displaying the plurality of representative words displays a representative word to which the second annotation is added with an emphasis if the second annotation is the emphasis instruction.

15. The medium according to claim 12, wherein the displaying the plurality of representative words displays a representative word to which the second annotation is added constantly if the second annotation is the emphasis instruction.
